(19) United States
(12) Patent Application Publication
(10) Pub. No.: US 2018/0365722 A1
(43) Pub. Date: Dec. 20, 2018

(54) BITCOIN CHASE MOBILE GAME

(71) Applicant: Cherry Ann Jack, Jersey City, NJ (US)

(72) Inventor: Cherry Ann Jack, Jersey City, NJ (US)

(21) Appl. No.: 15/626,725

(22) Filed: Jun. 19, 2017

(51) Int. Cl. G06Q 30/02; G07F 17/32

(52) U.S. Cl. CPC G06Q 30/0209; G06Q 30/0225; G07F 17/329; G07F 17/3255; G06Q 20/04; G07F 17/3248; G07F 17/3246; G07F 17/3218; G07F 17/323

(57) ABSTRACT

The present invention generally relates to mobile games played on a mobile device such as a phone, tablet or laptop that allows businesses to offer promotional rewards based on the player's physical presence, determined e.g. by GPS, or a based on a player's actions, such as purchasing a product or participation in an activity offered at the location of the business. In particular, embodiments of the present invention relate to a system, method and computer program product that allows business owners to offer bitcoin or digital currency to customers through a treasure hunting type game app or via a game website. In certain embodiments, the player can determine the presence of bitcoins or other rewards at a certain location by utilizing the mobile device as a detection tool to provide proximity- or location-based alerts or clues. In other embodiments, the game system may require the user to unlock a reward by a particular activity such as solving a puzzle or locating a particular location within the area of the business.

### FIELD OF THE INVENTION

The present invention generally relates to mobile games played on a mobile device such as a phone, tablet or laptop that allows businesses to offer promotional rewards based on the player's physical presence, determined e.g. by GPS, or a based on a player's actions, such as purchasing a product or participation in an activity offered at the location of the business. In particular, embodiments of the present invention relate to a system, method and computer program product that allows business owners to offer bitcoin or digital currency to customers through a treasure hunting type game app or via a game website. In certain embodiments, the player can determine the presence of bitcoins or other rewards at a certain location by utilizing the mobile device as a detection tool to provide proximity- or location-based alerts or clues. In other embodiments, the game system may require the user to unlock a reward by a particular activity such as solving a puzzle or locating a particular location within the area of the business.

### BACKGROUND OF THE INVENTION

Presently available location-based promotion and advertisement primarily relies on store-specific credit, loyalty programs and reward cards that fail to engage the customer and require a reward card or tag for each store, resulting in a cumbersome collection the customer has to carry around. Further, such cards or tags may cause customer dissatisfaction if a card/tag cannot be located or is lost. Mobile apps that scan and store reward cards simplify organizing multiple cards and avoid some of the dissatisfaction but require effort for scanning and most importantly fail to interact with the customer in an engaging way.

Therefore, there is a need in the art for a system and method that allows merchants and retailers to promote their store and business location by encouraging new customers to approach and enter and engaging existing customers to encourage their frequent return, and encourage all customers to participate in promotional activities occurring at a store. In particular, there is a need for a system and method that allows customers to be rewarded based on their physical presence at a determined location with rewards such as bitcoin or other digital currency, promotions such as raffle, lottery, reduced rates/discounts, free product sampling or testing, and participation in other offered activities. These and other features and advantages of the present invention will be explained and will become obvious to one skilled in the art through the summary of the invention that follows.

### SUMMARY OF THE INVENTION

The present invention generally relates to mobile games played on a mobile device such as a phone, table or laptop that offer promotional rewards based on the game system's determination of the player's physical presence, e.g. via GPS, or a particular action, such as purchasing a product or participation in a store activity. In particular, embodiments of the present invention relate to a system and method that allows store and business owners to offer bitcoin, digital currency, or other promotional rewards to existing or new local customers through a game app or website. Based on the game system's determination of a location-based qualifying action, the system provides the reward to the player. In certain embodiments, the player can determine the presence of bitcoins or other rewards at a certain location by utilizing the player's mobile device as a detection device to provide proximity- or location-based alerts, e.g. Virtual Reality, sound, visual signals including blinking, display of pictures, a merged virtual reality alert shown or otherwise communicated via virtual reality equipment, augmented reality overlay to the system's camera while “scanning” a shopfront for presence of rewards), or any other change in the user device or the user device's status or communication means that is suitable to communicate the alert. In other embodiments, the game system may require the user to unlock a reward by a particular activity such as solving a puzzle or locating a particular aisle.

According to an embodiment, the present invention provides a system for allowing businesses to provide location-based rewards to a player of an electronic game wherein the system comprises a plurality of operably connected system components; wherein the system components comprise a processor, a memory, computer executable code stored in non-volatile memory, a means to determine location, a communications means, and a data store that comprises the locations of one or more place of business, and that comprises available rewards for each place of business; wherein the system is configured to provide location-based clues to indicate that the location of one or more place of business that offers a reward is near, is located in a particular direction, or has been reached; wherein, optionally, the system is configured to determine and store one or more qualifying event for a player in a data store of the system, the qualifying events comprising one or more of action by the player at a particular physical location, action by the player at a particular time, current purchase at a particular place of business, prior purchase at a particular place of business, particular minimum amount of current purchase at a particular place of business, particular minimum amount of prior purchases at a particular place of business; wherein the system is configured to determine the player's reward eligibility for one or more rewards of one or more business based on one or more of the player's determined location and the one or more qualifying event; wherein the system is configured to credit a digital wallet or digital account associated with the player with the one or more reward upon the system's determination of reward eligibility; and wherein the system is configured to provide a reward-notification to the player.

In another embodiment, the system may be configured to automatically notify the player of one or more notification event that relates to a reward, the notification event including one or more of availability of digital currency or bitcoin, quantity of digital currency or bitcoin of a store or place of business, reloading of new digital currency or bitcoin by a place of business, availability of a raffle, availability of a lottery, availability of an electronic ticket.

In another embodiment, a system is provided wherein the rewards may comprise one or more of digital currency, bitcoins, entry into a raffle, entry into a lottery, electronic ticket, or a combination thereof.

In another embodiment, the clues provided by the system may comprise one or more signals selected from sound, visual display, vibration, LED blinking, display flashing, display showing a particular picture, display showing a video, camera display showing an augmented reality overlay overlaid over the output of the camera while “scanning” a shopfront for presence of rewards.

In another embodiment, the system may be configured to provide action-based clues for achieving eligibility to action-based rewards that indicate to the player which action is required to achieve a reward at a particular business location that offers the reward, and the system may be configured to provide a status that indicates the player's progress towards the action-based reward.

In another embodiment, the system may be configured to store a player's preferences, and the stored preferences may include type of reward, amount of award, type of business, one or more selection of individual businesses, favorite businesses, brands sold in one or more business, and favorite brands.

In another embodiment, the system may be configured to create and display a visual representation or map to guide the player through a sequence of multiple locations at which businesses offer rewards; the visual representation or map may be based on the player's location, the location of businesses at a distance surrounding the player, and one or more options from stored preferences; and the preferences may include one or more of allowed distance of travel, allowed time for travel to first destination, allowed time for travel to final destination, allowed method of transport, allowed geographical area, businesses of interest, and rewards of interest, and combinations thereof.

In another embodiment, the system may be configured to elicit a player's preferences in multiple sessions wherein the system provides short suggestions for a preference setting on an ongoing basis during game use.

In another embodiment, the system may be further configured to predict a player's preferences based on actions taken during one or more game session, and may be configured to automatically record and display a history of preferences as selectable options.

In another embodiment, the system may be configured to allow a player to switch between one or more preference settings, including a history of preference settings determined by the system during game play.

In another embodiment, the system may be configured to improve its preference options and preference suggestions by including into its computation the player's switches in preference option selections and surrounding circumstances during a switch, including location of the player, time of day, opening hours of businesses of interest to the player, and available businesses in a location.

In another embodiment, the system may comprise a user interface for business owners, and the user interface may be configured to allow the business owner to buy bitcoins directly from a digital currency provider for use in the system to provide location-based rewards to players.

According to an embodiment, the present invention provides a computer-implemented method for allowing businesses to automatically reward a player of an electronic game, said method comprising the steps of: providing the player with mobile electronic access to the game, wherein the game is configured for a system having a plurality of system components wherein the system components comprise a processor, a memory, computer executable code stored in non-volatile memory, a means to determine location, a communications means, and a data store that comprises the locations of one or more place of business, that comprises available rewards for each place of business, and that optionally comprises the player's qualifying conditions; automatically determining the player's location; automatically providing location-based clues to the player of the game, wherein the clues indicate that the location of one or more place of business that offers a reward is near the player's determined location, is located in a particular direction from the player's determined location, or has been reached by the player; optionally determining and storing qualifying events for a player in a data store of the system, the qualifying events comprising one or more of action by the player at a particular physical location, action by the player at a particular time, current purchase at a particular place of business, prior purchase at a particular place of business, particular minimum amount of current purchase at a particular place of business, particular minimum amount of prior purchases at a particular place of business; automatically determining the player's reward eligibility for one or more rewards of one or more business based on one or more of the player's determined location and the one or more qualifying event; automatically crediting a digital wallet or digital account associated with the player with the one or more reward based upon the determination of the player's reward eligibility; and automatically providing a reward-notification to the player.

In an embodiment of the inventive method, the rewards may comprise one or more of digital currency, bitcoins, entry into a raffle, entry into a lottery, electronic ticket, or a combination thereof.

In an embodiment of the inventive method, the method may further comprise the step of automatically notifying the player of one or more notification event that relates to a reward, the notification event including one or more of availability of digital currency or bitcoin, quantity of digital currency or bitcoin of a place of business, reloading of new digital currency or bitcoin by a store or place of business, availability of a raffle, availability of a lottery, availability of an electronic ticket.

In an embodiment of the inventive method, the clues provided may comprise one or more signals selected from sound, visual display, vibration, LED blinking, display flashing, display showing a particular picture, display showing a video, camera display showing an augmented reality overlay overlaid over the output of the camera while “scanning” a shopfront for presence of rewards.

In an embodiment, the method may further comprise the steps of: providing action-based clues for achieving eligibility to action-based rewards that indicate to the player which action is required to achieve a reward at a particular business location that offers the reward, and providing a status that indicates the player's progress towards the action-based reward.

In an embodiment of the invention, the method may further comprise the step of storing the player's preferences, and the preferences may include type of reward, amount of award, type of business, one or more selection of individual businesses, favorite businesses, brands sold in one or more business, favorite brands.

In an embodiment of the invention, the method may further comprise the steps of creating and displaying a visual representation or map to guide the player through a sequence of multiple locations at which businesses offer rewards; and the visual representation or map may be based on the player's location, the location of businesses at a distance surrounding the player, and one or more option from stored preferences; and the stored preferences may include one or more of allowed distance of travel, allowed time for travel to first destination, allowed time for travel to final destination, allowed method of transport, allowed geographical area, businesses of interest, and rewards of interest, and combinations thereof.

In an embodiment of the invention, the method may further comprise the step of eliciting a player's preferences in multiple sessions by providing short suggestions for a preference setting on an ongoing basis during game use.

In an embodiment of the invention, the method may further comprise the step of automatically predict a player's preferences based on actions taken during one or more game session, and automatically recording and displaying a history of preferences as selectable options.

In an embodiment of the invention, the method may further comprise the step of automatically offering a player to switch between one or more preference settings, including a history of preference settings determined by the system during game play.

In an embodiment of the invention, the method may further comprise the step of automatically improving the systems preference options and preference suggestions by including into the system;s computation the player's switches in preference option selections and surrounding circumstances during a switch, including location of the player, time of day, opening hours of businesses of interest to the player, and available businesses in a location.

In an embodiment of the invention, the method may further comprise a user interface for business owners, and the user interface may be configured to allow the business owner to buy bitcoins directly from a digital currency provider for use in the system to provide location-based rewards to players.

According to an embodiment, the present invention may provide a computer program product comprising instructions for allowing businesses to automatically reward a player of an electronic game, said computer program product comprising instructions in computer code to perform the steps of: providing the player with mobile electronic access to the game, wherein the game is configured for a system having a plurality of system components wherein the system components comprise a processor, a memory, computer executable code stored in non-volatile memory, a means to determine location, a communications means, and a data store that comprises the locations of one or more place of business, that comprises available rewards for each place of business, and that optionally comprises the player's qualifying conditions; automatically determining the player's location; automatically providing location-based clues to the player of the game, wherein the clues indicate that the location of one or more place of business that offers a reward is near the player's determined location, is located in a particular direction from the player's determined location, or has been reached by the player; optionally determining and storing qualifying events for a player in a data store of the system, the qualifying events comprising one or more of action by the player at a particular physical location, action by the player at a particular time, current purchase at a particular place of business, prior purchase at a particular place of business, particular minimum amount of current purchase at a particular place of business, particular minimum amount of prior purchases at a particular place of business; automatically determining the player's reward eligibility for one or more rewards of one or more business based on one or more of the player's determined location and the one or more qualifying event; automatically crediting a digital wallet or digital account associated with the player with the one or more reward based upon the determination of the player's reward eligibility; and automatically providing a reward-notification to the player.

The foregoing summary of the present invention with the preferred embodiments should not be construed to limit the scope of the invention. It should be understood and apparent to one skilled in the art that the embodiments of the invention thus described may be further modified without departing from the spirit and scope of the invention.

### BRIEF DESCRIPTION OF THE DRAWINGS

FIG. 1 illustrates a schematic overview of a computing device, in accordance with embodiments of the present invention;

FIG. 2 illustrates a schematic overview of a network, in accordance with embodiments of the present invention;

FIG. 3 illustrates a schematic overview of a method for businesses to automatically reward a player of an electronic game, in accordance with embodiments of the present invention.

### DETAILED DESCRIPTION OF THE INVENTION

The present invention generally relates to a system, method and computer program product for mobile games played on a mobile device such as a phone, table or laptop, that offer promotional rewards based on the game system's determination of the player's physical presence, e.g. via GPS, or a particular action, such as purchasing a product or participation in a store activity. In particular, embodiments of the present invention relate to a system, method and computer program product that allows business owners to offer bitcoin, digital currency, or other promotional rewards to existing or new local customers through a game app or website. Based on the game system's determination of a location-based qualifying action, the system provides the reward to the player. In certain embodiments, the player can determine the presence of bitcoins or other rewards at a certain location by utilizing the player's mobile device as a detection device to provide proximity- or location-based alerts, e.g. sound, visual signals including blinking, display of pictures, or augmented reality overlay to the system's camera while “scanning” a shopfront for presence of rewards). In other embodiments, the system may require the user to unlock a reward by a particular activity such as solving a puzzle or locating a particular aisle.

According to an embodiment of the present invention, the system may comprise a plurality of operably connected system components a plurality of which may be comprised in any computing device, preferably a mobile computing device such as a phone, smartphone, tablet, laptop or handheld game consoles, for example including PlayStation Portable (PSP), Playstation Vita, Nintendo Switch/3DS/2DS, Nvidia Shield, or similar. The system components generally comprise a processor, a memory, computer executable code stored in non-volatile memory, a means to determine location, a communications means, and a data store that comprises the locations of one or more place of business, and that comprises available rewards for each place of business. The system may be implemented in any number of configurations, for example, as an online application that can be accessed via a communication network such as Internet, or an application that can be downloaded to and executed on one or more mobile device. The mobile device may be, for example, a mobile phone, a smartphone, a tablet, a laptop; or other mobile computing device that is capable of executing mobile applications. The application may be accessed on any of the various operating systems, including, for example, iOS, Mac, Android, and Windows, as will be apparent to a person of ordinary skill in the art.

According to an embodiment of the present invention, the system may credit a reward to a player's digital account or to a digital wallet that a player uses. A digital wallet allows a user to make electronic commerce transactions such as sending and/or receiving digital currency, e.g. bitcoins. The wallet may be an application running on the user's mobile device or computer, a mobile app, or a service offered by a website. In case of Bitcoin, the digital wallet adds a transaction to a public ledger of the bitcoin network by informing a single node on the Bitcoin network. Various digital currency providers exist, including, for example, BitChase who offers Bitcoin. Regardless of the type of the digital wallet, its purpose includes storing private keys of the user, sending digital currency to other users, and generating addresses, so that the user can receive bitcoins from other users, and viewing transaction history and current balance. A digital currency or Bitcoin address is an identifier that represents a possible destination for a Bitcoin payment. A digital currency or Bitcoin address can be generated by any user of Bitcoin, and can be obtained using an account at an exchange or online wallet service. Cryptocurrency digital wallets like Bitcoin typically have a public-private key pair. The public key serves as the address or hostname of the digital wallet, and the private key serves as access for any person holding the private key.

According to an embodiment of the present invention, the reward credited to a player's digital wallet by the system may be a digital currency, for example Bitcoin. Digital currencies are currencies that are kept in a digital wallet accessible via an electronic device and/or web application. Examples include crypto currencies like Bitcoin, or a non-crypto currency like the Ven. Digital currencies can be used to buy physical goods and services, like traditional money. The digital currency may be decentralized, as is for example the Bitcoin. The US Department of Treasury defines a decentralized currency as a “currency (1) that has no central repository and no single administrator, and (2) that persons may obtain by their own computing or manufacturing effort”. Trust in the currency is based on the “transaction ledger which is cryptographically verified, and jointly maintained by the currency's users”. Creating Bitcoins involves a process called mining, in which computer network participants provide their computing power, and verify and record payments into a public ledger in exchange for transaction fees and newly minted bitcoins. Bitcoins may be obtained by mining or in exchange for products, services, or other currencies. Users send and receive bitcoins using wallet software on a personal computer, mobile device, or a web application.

According to an embodiment of the present invention, the reward credited to a player's digital wallet by the system may be send over a communication network, including a social network. Communication networks may include, for example, email, SMS, and App installed on a smartphone/tablet/laptop. The social network may include, for example, Twitter, Facebook, email, Reddit, WhatsApp. A user may be registered with a bitcoin service provider, such as the bitcoin DNS service, and use the service provider to send and/or receive bitcoins using bitcoin addresses of the users.

According to an embodiment of the present invention, the reward credited to a player's digital account by the system may be participation in promotional activities as described herein (e.g. raffles, lotteries, free product samples, etc.) that may be offered by various businesses.

According to an embodiment of the present invention, the businesses may include any participating business that sells or offers products or services to consumers at a particular location, including, for example, retailers, supermarkets, cinemas, theaters, opera houses, museums, restaurants, bakeries, coffees shops, grocery stores, farmer's markets, vending machines, beauty salon, nail salon, barber shop, fitness center, dry cleaner, travel agencies, print shops, hardware stores, plumber, electrician, carpenter, architect, landscaper, tutoring services, accountants, tax preparers, dentist, optician, pharmacy, doctor's office, veterinary, gas station, automotive repair, taxi service, transportation ticket counters (bus, train, plane), and many more.

According to an embodiment of the present invention, the game may be any variation of the theme of a chase, or treasure hunt in which players follow a set of directions and discover clues provided by the system in the process. A game may involve arriving at a particular location, or arriving at a plurality of locations (optionally in a particular sequence). In addition, the game may require certain actions of the player at the start, on route, or upon arrival at the final location to proceed within the game. Player actions may include various activities at the business providing the reward (e.g. purchase, participation in raffle, lottery or similar, locating a particular aisle or product, taking and/or posting a photo of the business, writing and posting a business review, sampling a product, writing and posting a product review, etc.), and/or may involve solving one or more puzzle or riddle that may or may not be related to the reward-offering business. Puzzles or riddles may include clues hidden e.g. in a story or in the graphics of an illustration, picture or photo, to find the “treasure”/reward, e.g. a Bitcoin, at a real world location. Alternatively or additionally, the player may be presented with questions to answer. Questions may be about any subject, and may or may not be business related, for example, including specifics of the business, the business location, specifics of the business at the particular time of arrival at its location, products offered by the business, subjects of interest to a particular customer group, or general interest subjects. The system may require one or more player actions at any time of the game, for example, at the start, on route, or upon arrival at the final location. For example, the player may be required to purchase an item in the store or place of business as part of the chase.

According to an embodiment of the present invention, the game may be configured for a single player, or may be configured for a group/team of players that may or may not compete for the one or more reward. The system may be configured accordingly to allow interaction of a number of players in a particular game, and may be configured with 1^{st} and 2^{nd} rewards, based on arrival times on route or at the final destination.

According to an embodiment of the present invention, the game may proceed along a route or trail that may be on foot or may require the use vehicles, cars, bicycles, trains, subway, buses, ferries, and other private or public transport. They may follow circular routes, zigzag between locations, or be linear, and may or may not include repeat visits to the same location (for example to engage in a 2^{nd} required action/activity).

The following paragraphs describe embodiments of the present invention with respect to bitcoins. However, it should be noted that the embodiments are not limited to bitcoins, and are applicable to any digital currency, as will be apparent to a person of ordinary skill in the art.

According to an embodiment of the present invention, the system may automatically credit a reward to a player's account. The player's account may be an account held by the game provider, or may be an account linked to the game account, for example a digital currency account, a bitcoin account, a PayPal® account, or similar.

According to an embodiment of the present invention, the reward automatically credited to the player by the system may constitute participation in offered store activities such as a survey, raffle, lottery, product sampling, product testing, providing a product reviews, or similar, or any combination thereof.

According to an embodiment of the present invention, the reward automatically credited to the player by the system may require a qualifying action, including for example, virtual or physical presence at a certain location, entry into the store or business location, presence at a particular store location or location within a store (e.g. particular aisle or shelf, outlet, storefront, product categories in a virtual store), purchase, purchase of a particular amount, purchase of a particular product or class of products, or participation in offered store activities. Such store activities may include a survey, raffle, lottery, product sampling, product testing, providing a product review, or similar, or any combination thereof.

According to an embodiment of the present invention, the player may be required to determine the presence of bitcoins or other rewards at a certain location by utilizing the player's mobile device as a detection device to detect proximity- or location-based clues or signals, e.g. sound, visual, and/or vibration. For example, an LED or display may blink, the display may show a picture or video, or an augmented reality overlay to the output of the camera while “scanning” a shopfront for presence of rewards.

According to an embodiment of the present invention, the system may be configured to provide customization options to the player. For example, the system may provide a list of options to limit rewards or stores to the ones of interest, e.g. by type of reward, type of store, amount of bitcoin/digital currency, minimum amount of reward, geographical area, store location, distance from location of player etc.

According to an embodiment of the present invention, the system may automatically determine a player's location and be configured to automatically adjust an option list based on distance from the player, in miles or in kilometer, e.g. 0-0.1 mi/km, 0-0.2 mi/km, 0-0.5 mi/km, 0-1 mi/km, or 0-2 mi/km, or 0-5 mi/km, 0-10 mi/km, 0-20 mi/km, or more distant locations.

According to an embodiment of the present invention, the system may automatically provide a reward-notification upon the system's determination of eligibility for a reward and crediting of the reward to the player's account. The notification may be any signal of the mobile device used by the player that comprises one or more of the system components and that is suitable to alert the player, for example, suitable notification signals include sound, visual, visual display, email, text message, post to a linked social network account of the player, inbox message to digital wallet, and similar. The system may be configured to provide a user interface with selectable notification options in the system settings to allow the player to select one or more notification option, and to optionally link one or more social network account.

According to an embodiment of the present invention, the system may comprise a means to determine location. For example, the mobile computing device that comprises one or more system components may also comprise a GPS, or a radio frequency identification (RFID) tag, that enables the device software to provide a proximity trigger or send a response when the mobile device enters or leaves a particular area. Alternatively, Wi-Fi and cellular data may serve as means to determine location.

According to an embodiment of the present invention, the system may implement or rely on an existing geo-fence, a virtual geographic boundary for a real-world geographic. A geo-fence may be active or passive. Active geofences require an end user to opt-in to location services and a mobile app to be open, and may utilize GPS or RFID. Passive geofences are always on, utilize Wi-Fi and cellular data instead of GPS or RFID, and work in the background.

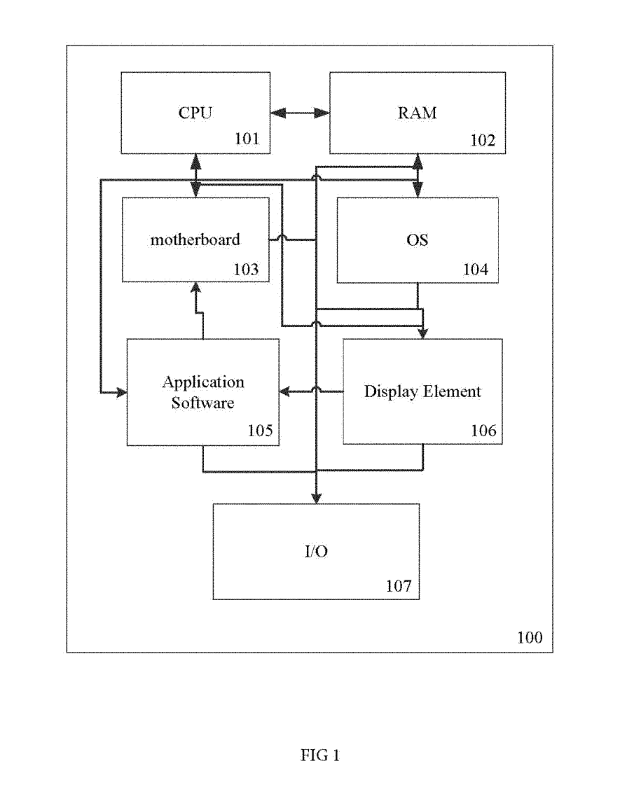

According to an embodiment of the present invention, the system and method is accomplished through the use of one or more computing devices. As shown in FIG. 1, One of ordinary skill in the art would appreciate that a computing device 100 appropriate for use with embodiments of the present application may generally be comprised of one or more of a Central processing Unit (CPU) 101, Random Access Memory (RAM) 102, a storage medium (e.g., hard disk drive, solid state drive, flash memory, cloud storage) and mother board 103, an operating system (OS) 104, one or more application software 105, display element 106 and one or more input/output devices/means 107. Examples of computing devices usable with embodiments of the present invention include, but are not limited to, personal computers, smart phones, laptops, mobile computing devices and tablet PCs and servers. One of ordinary skill in the art would understand that any number of computing devices could be used, and embodiments of the present invention are contemplated for use with any computing device.

In an exemplary embodiment according to the present invention, data may be provided to the system, stored by the system and/or provided by the system to users of the system across local area networks (LANs) (e.g., office networks, home networks) or wide area networks (WANs) (e.g., the Internet). In accordance with the previous embodiment, the system may be comprised of numerous servers communicatively connected across one or more LANs and/or WANs. One of ordinary skill in the art would appreciate that there are numerous manners in which the system could be configured and embodiments of the present invention are contemplated for use with any configuration.

In general, the system and methods provided herein may be consumed by a user of a computing device whether connected to a network or not. According to an embodiment of the present invention, some of the applications of the present invention may not be accessible when not connected to a network, however a user may be able to compose data offline that will be consumed by the system when the user is later connected to a network.

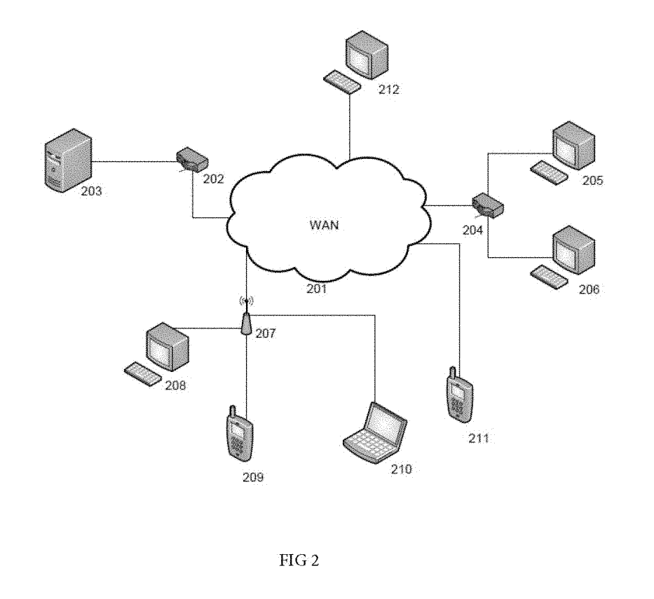

Referring to FIG. 2, a schematic overview of a system in accordance with an embodiment of the present invention is shown. The system is comprised of one or more application servers 203 for electronically storing information used by the system. Applications in the server 203 may retrieve and manipulate information in storage devices and exchange information through a WAN 201 (e.g., the Internet). Applications in server 203 may also be used to manipulate information stored remotely and process and analyze data stored remotely across a WAN 201 (e.g., the Internet).

According to an exemplary embodiment, as shown in FIG. 2, exchange of information through the WAN 201 or other network may occur through one or more high speed connections. In some cases, high speed connections may be over-the-air (OTA), passed through networked systems, directly connected to one or more WANs 201 or directed through one or more routers 202. Router(s) 202 are completely optional and other embodiments in accordance with the present invention may or may not utilize one or more routers 202. One of ordinary skill in the art would appreciate that there are numerous ways server 203 may connect to WAN 201 for the exchange of information, and embodiments of the present invention are contemplated for use with any method for connecting to networks for the purpose of exchanging information. Further, while this application refers to high speed connections, embodiments of the present invention may be utilized with connections of any speed.

Components of the system may connect to server 203 via WAN 201 or other network in numerous ways. For instance, a component may connect to the system i) through a computing device 212 directly connected to the WAN 201, ii) through a computing device 205, 206 connected to the WAN 201 through a routing device 204, iii) through a computing device 208, 209, 210 connected to a wireless access point 207 or iv) through a computing device 211 via a wireless connection (e.g., CDMA, GMS, 3G, 4G) to the WAN 201. One of ordinary skill in the art would appreciate that there are numerous ways that a component may connect to server 203 via WAN 201 or other network, and embodiments of the present invention are contemplated for use with any method for connecting to server 203 via WAN 201 or other network. Furthermore, server 203 could be comprised of a personal computing device, such as a smartphone, acting as a host for other computing devices to connect to.

According to an embodiment of the present invention, the communications means of the system may be, for instance, any means for communicating data, voice or video communications over one or more networks or to one or more peripheral devices attached to the system. Appropriate communications means may include, but are not limited to, wireless connections, wired connections, cellular connections, data port connections, Bluetooth® connections, or any combination thereof. One of ordinary skill in the art would appreciate that there are numerous communications means that may be utilized with embodiments of the present invention, and embodiments of the present invention are contemplated for use with any communications means.

### Exemplary Embodiments

Turning now to FIG. 1, a schematic overview of a computing device for use in accordance with embodiments of the present invention is shown. Typical components of a computing device that may be used in embodiments of the present invention are illustrated;

In FIG. 2, a schematic overview of a network for use in accordance with embodiments of the present invention is shown. Typical network components that may be used in embodiments of the present invention are illustrated.

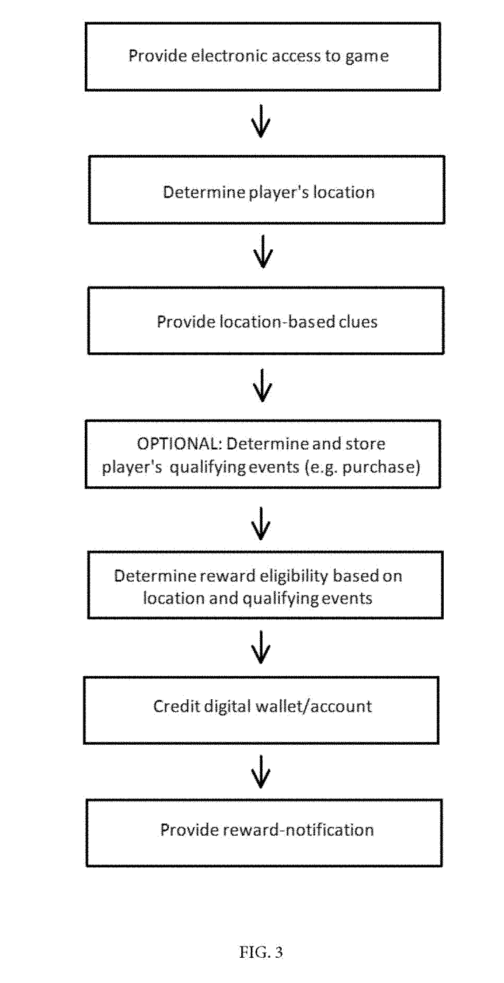

In FIG. 3, a schematic overview of a method for businesses to automatically reward a player of an electronic game in accordance with embodiments of the present invention is shown. Various steps of a particular method according to embodiments of the present invention are illustrated. In alternate embodiments, the method may have additional or fewer steps. One of ordinary skill in the art would appreciate that the method may be operable with a number of optional steps, and embodiments of the present invention are contemplated for use with any such optional steps.

Traditionally, a computer program consists of a finite sequence of computational instructions or program instructions. It will be appreciated that a computing device can receive such a computer program and, by processing the computational instructions thereof, produce a further technical effect.

A computing device includes one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computing device can include any and all suitable combinations of at least one general purpose computer, special-purpose computer, programmable data processing apparatus, processor, processor architecture, and so on.

It will be understood that a computer can include a computer-readable storage medium and that this medium may be internal or external, removable and replaceable, or fixed. It will also be understood that a computer can include a Basic Input/Output System (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the invention as claimed herein could include an optical computer, quantum computer, analog computer, or the like.

Regardless of the type of computer program or computer involved, a computer program can be loaded onto a computer, network of computers, or system, to produce one or more particular machine/system that can perform any and all of the functions and/or method steps described or depicted herein. The particular machine or machines, as part of the system, provide a means for carrying out any and all of the functions of the system and/or the method steps described or depicted herein.

Any combination of one or more computer readable medium(s) may be utilized, for example to store and/or transfer instructions that implement the method of the present invention, and thus convert a general purpose computer or system into a specialized computer or system that carries out any and all of the depicted functions and/or method steps. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

According to an embodiment of the present invention, a data store may be comprised of one or more of a database, file storage system, relational data storage system or any other data system or structure configured to store data, preferably in a relational manner. The data store may be a relational database, working in conjunction with a relational database management system (RDBMS) for receiving, processing and storing data. Alternatively or additionally, the data store may comprise one or more databases for storing information related to the processing of moving information and estimate information as well one or more databases configured for storage and retrieval of moving information and estimate information.

Computer program instructions can be stored in a computer-readable memory capable of directing a computer or other programmable data processing apparatus to function in a particular manner. The instructions stored in the computer-readable memory constitute an article of manufacture or product including computer-readable instructions for implementing any and all of the functions and methods described or depicted herein.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these. All such implementations are within the scope of the present disclosure.

In view of the foregoing, it will now be appreciated that elements of the block diagrams and flowchart illustrations support combinations of means for performing the specified functions, combinations of steps for performing the specified functions, program instruction means for performing the specified functions, and so on.

It will be appreciated that computer program instructions may include computer executable code. A variety of languages for expressing computer program instructions are possible, including without limitation C, C++, Java, JavaScript, assembly language, Lisp, HTML, Perl, and so on. Such languages may include assembly languages, hardware description languages, database programming languages, functional programming languages, imperative programming languages, and so on. In some embodiments, computer program instructions can be stored, compiled, or interpreted to run on a computer, a programmable data processing apparatus, a heterogeneous combination of processors or processor architectures, and so on. Without limitation, embodiments of the system as described herein can take the form of web-based computer software, which includes client/server software, software-as-a-service, peer-to-peer software, or the like.

In some embodiments, a computer enables execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. The thread can spawn other threads, which can themselves have assigned priorities associated with them. In some embodiments, a computer can process these threads based on priority or any other order based on instructions provided in the program code.

Unless explicitly stated or otherwise clear from the context, the verbs “execute” and “process” are used interchangeably to indicate execute, process, interpret, compile, assemble, link, load, any and all combinations of the foregoing, or the like. Therefore, embodiments that execute or process computer program instructions, computer-executable code, or the like can suitably act upon the instructions or code in any and all of the ways just described.

The functions and operations presented herein are not inherently related to any particular computer or other apparatus or system. Various general-purpose systems may also be used with programs in accordance with the teachings herein, or it may prove convenient to construct more specialized apparatus to perform the required method steps. The required structure for a variety of these systems will be apparent to those of skill in the art, along with equivalent variations. In addition, embodiments of the invention are not described with reference to any particular programming language. It is appreciated that a variety of programming languages may be used to implement the present teachings as described herein. Embodiments of the invention are well suited to a wide variety of computer network systems over numerous topologies. Within this field, the configuration and management of large networks include storage devices and computers that are communicatively coupled to dissimilar computers and storage devices over a network, such as the Internet.

Throughout this disclosure and elsewhere, block diagrams and flowchart illustrations depict apparatuses (i.e., systems) and methods, and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) can be implemented by computer program instructions; by special-purpose, hardware-based computer systems; by combinations of special purpose hardware and computer instructions; by combinations of general purpose hardware and computer instructions; and so on—any and all of which may be generally referred to herein as a “circuit,” “module,” or “system.”

While the foregoing drawings and description set forth functional aspects of the disclosed systems and methods, no particular arrangement of software for implementing these functional aspects should be inferred from these descriptions unless explicitly stated or otherwise clear from the context.

Each element in flowchart illustrations may depict a step, or group of steps, of a computer-implemented method. Further, each step may contain one or more sub-steps. For the purpose of illustration, these steps (as well as any and all other steps identified and described above) are presented in order. It will be understood that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

The functions, systems and methods herein described could be utilized and presented in a multitude of languages. Individual systems may be presented in one or more languages and the language may be changed with ease at any point in the process or methods described above. One of ordinary skill in the art would appreciate that there are numerous languages the system could be provided in, and embodiments of the present invention are contemplated for use with any language.

While multiple embodiments are disclosed, still other embodiments of the present invention will become apparent to those skilled in the art from this detailed description. There may be aspects of this invention that may be practiced without the implementation of some features as they are described. It should be understood that some details have not been described in detail in order to not unnecessarily obscure focus of the invention. The invention is capable of myriad modifications in various obvious aspects, all without departing from the spirit and scope of the present invention. Accordingly, the drawings and descriptions are to be regarded as illustrative in nature and not restrictive.

1. A system for allowing businesses to provide location-based rewards to a player of an electronic game wherein the system comprises a plurality of operably connected system components;
wherein the system components comprise a processor, a memory, computer executable code stored in non-volatile memory, a means to determine location, a communications means, and a data store that comprises the locations of one or more place of business, and that comprises available rewards for each place of business;
wherein the system is configured to provide location-based clues to indicate that the location of one or more place of business that offers a reward is near, is located in a particular direction, or has been reached;
wherein, optionally, the system is configured to determine and store one or more qualifying event for a player in a data store of the system, the qualifying events comprising one or more of action by the player at a particular physical location, action by the player at a particular time, current purchase at a particular place of business, prior purchase at a particular place of business, particular minimum amount of current purchase at a particular place of business, particular minimum amount of prior purchases at a particular place of business;
wherein the system is configured to determine the player's reward eligibility for one or more rewards of one or more business based on one or more of the player's determined location and the one or more qualifying event;
wherein the system is configured to credit a digital wallet or digital account associated with the player with the one or more reward upon the system's determination of reward eligibility;
wherein the system is configured to provide a reward-notification to the player.

2. The system of claim 1 wherein the rewards comprise one or more of digital currency, bitcoins, entry into a raffle, entry into a lottery, electronic ticket, or a combination thereof.

3. The system of claim 2, wherein the system is configured to automatically notify the player of one or more notification event that relates to a reward, the notification event including one or more of availability of digital currency or bitcoin, quantity of digital currency or bitcoin of a store or place of business, reloading of new digital currency or bitcoin by a place of business, availability of a raffle, availability of a lottery, availability of an electronic ticket.

4. The system of claim 1, wherein the clues provided by the system comprise one or more signals selected from sound, visual display, vibration, LED blinking, display flashing, display showing a particular picture, display showing a video, camera display showing an augmented reality overlay overlaid over the output of the camera while “scanning” a shopfront for presence of rewards.

5. The system of claim 1 wherein the system is configured to provide action-based clues for achieving eligibility to action-based rewards that indicate to the player which action is required to achieve a reward at a particular business location that offers the reward, and wherein the system is configured to provide a status that indicates the player's progress towards the action-based reward.

6. The system of claim 1, wherein the system is configured to store a player's preferences, and wherein the preferences include type of reward, amount of award, type of business, one or more selection of individual businesses, favorite businesses, brands sold in one or more business, and favorite brands.

7. The system of claim 1, wherein the system is configured to create and display a visual representation or map to guide the player through a sequence of multiple locations at which businesses offer rewards;
wherein the visual representation or map is based on the player's location, the location of businesses at a distance surrounding the player, and one or more options from stored preferences;
wherein the preferences include one or more of allowed distance of travel, allowed time for travel to first destination, allowed time for travel to final destination, allowed method of transport, allowed geographical area, businesses of interest, and rewards of interest, and combinations thereof.

8. The system of claim 1 wherein the system is configured to elicit a player's preferences in multiple sessions wherein the system provides short suggestions for a preference setting on an ongoing basis during game use.

9. The system of claim 8 wherein the system is configured to improve its preference options and preference suggestions by including into its computation the player's switches in preference option selections and surrounding circumstances during a switch, including location of the player, time of day, opening hours of businesses of interest to the player, and available businesses in a location.

10. The system of claim 1, wherein the system comprises a user interface for business owners, and the user interface is configured to allow the business owner to buy bitcoins directly from a digital currency provider for use in the system to provide location-based rewards to players.

11. A computer-implemented method for allowing businesses to automatically reward a player of an electronic game, said method comprising the steps of:
providing the player with mobile electronic access to the game, wherein the game is configured for a system having a plurality of system components wherein the system components comprise a processor, a memory, computer executable code stored in non-volatile memory, a means to determine location, a communications means, and a data store that comprises the locations of one or more place of business, that comprises available rewards for each place of business, and that optionally comprises the player's qualifying conditions;
automatically determining the player's location;
automatically providing location-based clues to the player of the game, wherein the clues indicate that the location of one or more place of business that offers a reward is near the player's determined location, is located in a particular direction from the player's determined location, or has been reached by the player;
optionally determining and storing qualifying events for a player in a data store of the system, the qualifying events comprising one or more of action by the player at a particular physical location, action by the player at a particular time, current purchase at a particular place of business, prior purchase at a particular place of business, particular minimum amount of current purchase at a particular place of business, particular minimum amount of prior purchases at a particular place of business;
automatically determining the player's reward eligibility for one or more rewards of one or more business based on one or more of the player's determined location and the one or more qualifying event;
automatically crediting a digital wallet or digital account associated with the player with the one or more reward based upon the determination of the player's reward eligibility; and
automatically providing a reward-notification to the player.

12. The method of claim 11, wherein the rewards comprise one or more of digital currency, bitcoins, entry into a raffle, entry into a lottery, electronic ticket, or a combination thereof.

13. The method of claim 12, further comprising the step of automatically notifying the player of one or more notification event that relates to a reward, the notification event including one or more of availability of digital currency or bitcoin, quantity of digital currency or bitcoin of a place of business, reloading of new digital currency or bitcoin by a store or place of business, availability of a raffle, availability of a lottery, availability of an electronic ticket.

14. The method of claim 11, wherein the clues provided comprise one or more signals selected from sound, visual display, vibration, LED blinking, display flashing, display showing a particular picture, display showing a video, camera display showing an augmented reality overlay overlaid over the output of the camera while “scanning” a shopfront for presence of rewards.

15. The method of claim 11, further comprising the steps of:
providing action-based clues for achieving eligibility to action-based rewards that indicate to the player which action is required to achieve a reward at a particular business location that offers the reward, and
providing a status that indicates the player's progress towards the action-based reward.

16. The method of claim 11, further comprising the step of storing the player's preferences, and wherein the preferences include type of reward, amount of award, type of business, one or more selection of individual businesses, favorite businesses, brands sold in one or more business, favorite brands.

17. The method of claim 11, further comprising the steps of creating and displaying a visual representation or map to guide the player through a sequence of multiple locations at which businesses offer rewards;
wherein the visual representation or map is based on the player's location, the location of businesses at a distance surrounding the player, and one or more option from stored preferences; and
wherein the stored preferences include one or more of allowed distance of travel, allowed time for travel to first destination, allowed time for travel to final destination, allowed method of transport, allowed geographical area, businesses of interest, and rewards of interest, and combinations thereof.

18. The method of claim 11, further comprising the step of eliciting a player's preferences in multiple sessions by providing short suggestions for a preference setting on an ongoing basis during game use.

19. The method of claim 18, further comprising the step of automatically improving the systems preference options and preference suggestions by including into the system's computation the player's switches in preference option selections and surrounding circumstances during a switch, including location of the player, time of day, opening hours of businesses of interest to the player, and available businesses in a location.

20. The method of claim 11, wherein the system comprises a user interface for business owners, and the user interface is configured to allow the business owner to buy bitcoins directly from a digital currency provider for use in the system to provide location-based rewards to players.
